(19) United States
(12) Patent Application Publication
(10) Pub. No.: US 2007/0005231 A1
(43) Pub. Date: Jan. 4, 2007

(54) Traffic jam detection system and method

(75) Inventor: Kazuhiko Seguchi, Inagi-shi (JP)

Correspondence Address: YOUNG & BASILE, P.C., 3001 WEST BIG BEAVER ROAD, SUITE 624, TROY, MI, 48084, US

(73) Assignee: Nissan Motor Co., Ltd., Yokohama-shi (JP)

(21) Appl. No.: 11/476,490

(22) Filed: Jun. 28, 2006

(30) Foreign Application Priority Data
Jun. 29, 2005 (JP) 2005-189701

(51) Int. Cl. G08G 1/00

(52) U.S. Cl. 701/117; 340/933

(57) ABSTRACT

A traffic jam detection system and method to estimate a traffic jam condition ahead of a vehicle. When a vehicle arrives at the tail end of a traffic jam, information is related to the tail end of the traffic jam is transmitted to an information center. The information center collects this information related to plural traffic jams from on-vehicle information terminals of a number of vehicles and develops estimated tail end information for each of the traffic jams. The information center transmits the estimated tail end information to vehicles approaching traffic jams for the driver to determine whether a traffic jam should be avoided or not.

### TECHNICAL FIELD

The present invention pertains in general to a traffic jam detection system and method for detecting the locations of traffic jams.

### BACKGROUND

Traffic jam information detectors are known through, for example, Japanese Kokai Patent Application No. 2004-234649. According to this traffic jam information detector, traffic information presented by a public office is utilized in order to predict future traffic jams. In this detector, and others, only traffic jams on major roadways, such as highways, can be predicted.

### BRIEF SUMMARY OF THE INVENTION

According to one aspect of a traffic jam detection system, the system comprises a first on-vehicle information terminal including a controller operable to detect an arrival of the vehicle at a tail end of a traffic jam and a communication device adapted to transmit information regarding the tail end of the traffic jam external of the vehicle and to receive estimated traffic jam information from external of the vehicle.

Another example of a traffic jam detection system comprises means for transmitting information pertaining to a tail end of a traffic jam from a vehicle to an information center when an arrival of the vehicle at the tail end of the traffic jam is detected, means for receiving current information for estimating a condition of a current traffic jam ahead of the vehicle and means for estimating the condition of the current traffic jam ahead of the vehicle based on the current information.

A traffic jam detection method according to another aspect of the invention comprises, for example, transmitting information pertaining to a tail end of a traffic jam from a vehicle to an information center when an arrival of the vehicle at the tail end of the traffic jam is detected, receiving current information for estimating a condition of a current traffic jam ahead of the vehicle and estimating the condition of the current traffic jam ahead of the vehicle based on the current information.

### BRIEF DESCRIPTION OF THE DRAWINGS

The description herein makes reference to the accompanying drawings wherein like reference numerals refer to like parts throughout the several views, and wherein:

FIG. 1 is a block diagram showing the configuration of an embodiment of the traffic jam detection system taught herein;

FIG. 2 is a diagram showing an example of vehicular velocity change information;

FIG. 3 is a diagram showing an example of a vehicular velocity change record;

FIG. 4 is a flow chart showing processing to be carried out by an on-vehicle information terminal; and

FIG. 5 is a flow chart showing processing to be carried out by an information center.

### DETAILED DESCRIPTION OF EMBODIMENTS OF THE INVENTION

In embodiments of the invention disclosed herein, pieces of information for estimating an increase or decrease in the lengths of traffic jams are computed based on pieces of information on the tail ends of traffic jams received from vehicles. The condition of the traffic jam ahead of a vehicle is estimated based on these pieces of information. As a result, conditions of traffic jams in areas where no traffic information is available from a public source can also be estimated.

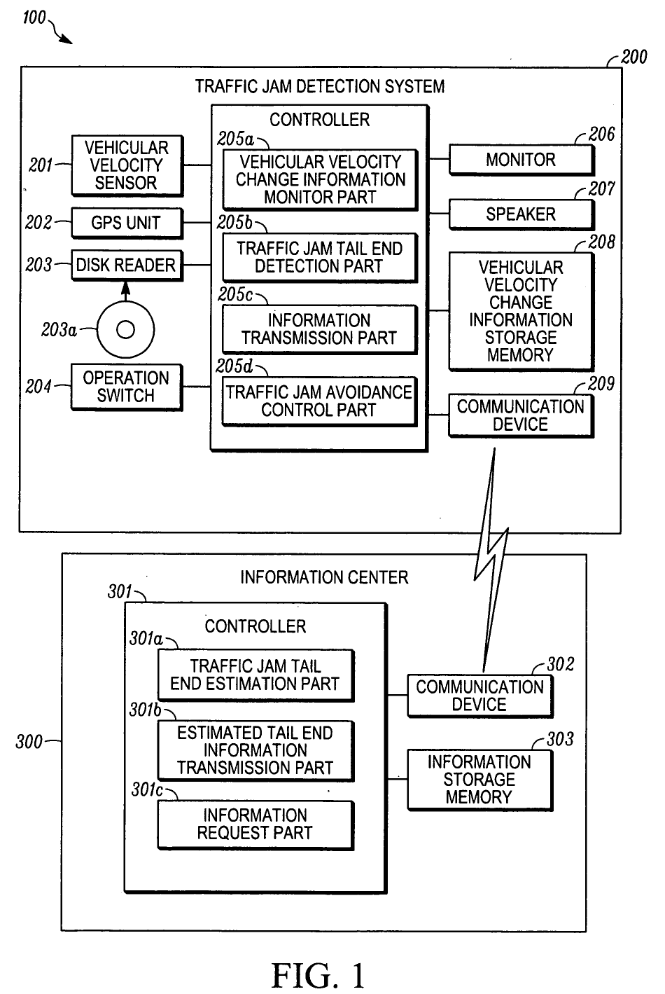

FIG. 1 is a block diagram showing the configuration of an embodiment of a traffic jam detection system. In this traffic jam detection system 100, on-vehicle information terminal 200 installed on a vehicle and information center 300 are connected to each other using prescribed communication channels.

On-vehicle information terminal 200 may be a navigation device, for example. As shown, it is configured with vehicular velocity sensor 201 that detects the velocity of the vehicle, GPS unit 202 that detects the current position of the vehicle upon receiving GPS signals from GPS (Global Positioning System) satellites, disk reader 203 that reads map information from map disk 203a, operation switch 204 to be actuated by a user or driver, controller 205 configured with a CPU, a memory and other peripheral circuits in order to execute various kinds of processing to be described later, monitor 206 displaying a road map read from map disk 203a and various kinds of information, speaker 207 that outputs audio information, such as audio guidance, vehicular velocity change information storage memory 208 that stores vehicular velocity change information to be described later, and communication device 209. Communication device 209 can be, for example, a portable telephone unit used to communicate with information center 300 via a communication channel.

Map data at multiple scales are stored in map disk 203a. The stored map data include road data for expressing roads in the form of nodes and links. In the case of this road data an intersection corresponds to a node, and a line segment connecting nodes corresponds to a link. In the present embodiment, each node is assigned a node ID as an identification number, and each link is assigned a link ID (road number) as an identification number. In addition, an arbitrary point on the map data can be specified using coordinate values for the map data.

Controller 205 has vehicular velocity change information monitor part 205a, traffic jam tail end detection part 205b, information transmission part 205c and traffic jam avoidance control part 205d.

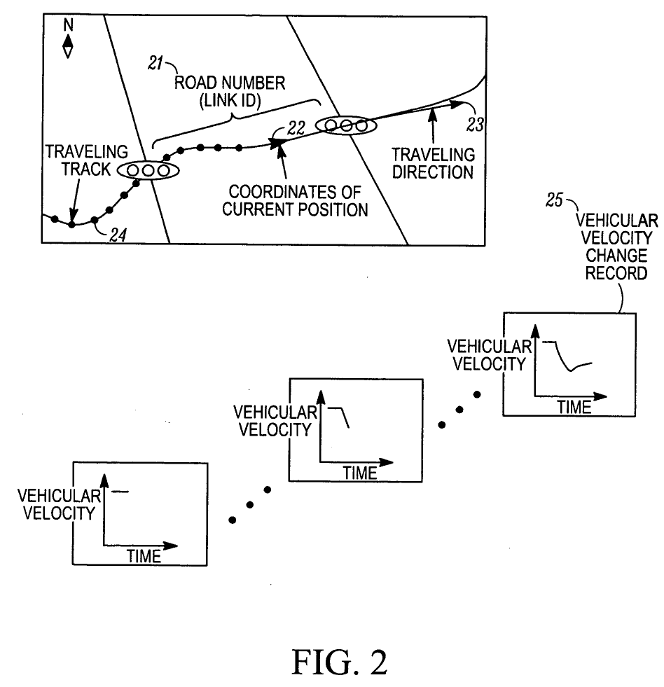

Vehicular velocity change information monitor part 205a stores traveling conditions of the vehicle into vehicular velocity change information storage memory 208 as vehicular velocity change information. As shown in FIG. 2, the vehicular velocity change information includes link ID 21 for the road the vehicle is currently traveling, current position coordinates 22 of the vehicle that are detected based on output from GPS unit 202, traveling direction 23 detected based on changes in the current position of the vehicle, traveling track 24, and vehicular velocity change record 25 that indicates changes in the vehicular velocity of the vehicle over time that are detected based on output from vehicular velocity sensor 201.

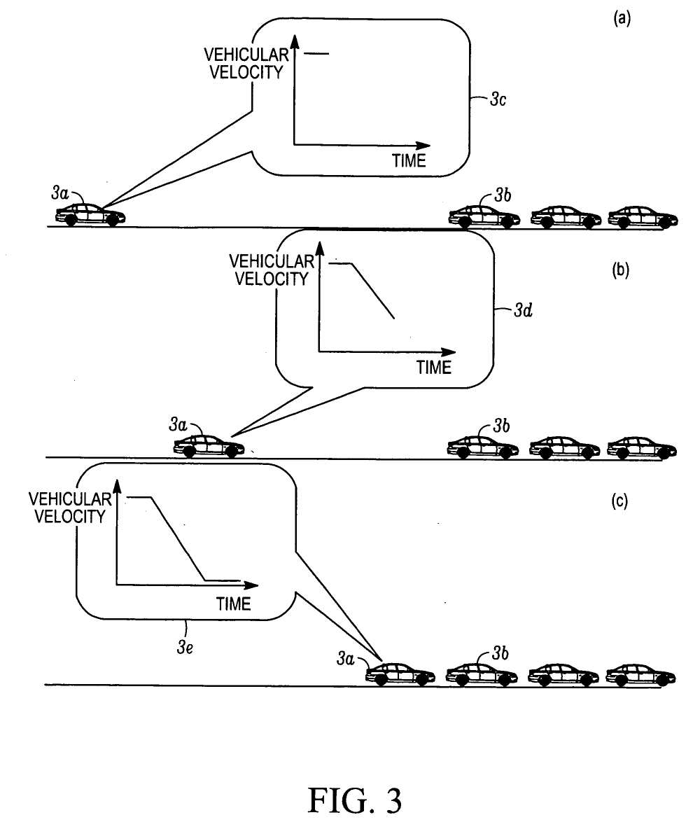

An example of vehicular velocity change record 25 when there is a traffic jam in front of the vehicle is shown in FIG. 3. As shown in (a), when the distance from vehicle 3a to vehicle 3b located at the tail end of the traffic jam is long, and vehicle 3a is traveling at constant velocity, vehicular velocity change record 25 is similar to the graph indicated by symbol 3c. As shown in (b), when the driver subsequently notices the traffic jam ahead as vehicle 3a approaches vehicle 3b, the driver reduces speed, so vehicular velocity change record 25 updates to the graph indicated by symbol 3d. That is, the vehicular velocity decreases as time goes by.

As shown in (c), when vehicle 3a arrives directly behind vehicle 3b at the tail end of the traffic jam vehicle 3a either stops or goes slowly, so vehicular velocity change record 25 becomes similar to the graph indicated by symbol 3e. The vehicular velocity is either zero (0) or a low speed. Here, the recording of the vehicular velocity change information by vehicular velocity change information monitor part 205a is to be carried out at a prescribed time interval, and this interval can be changed depending upon conditions or driver preference.

Traffic jam tail end detection part 205b judges that the vehicle has arrived at the tail end of the traffic jam as shown in (c) of FIG. 3 when the vehicular velocity is equal to or lower than a prescribed value for at least a prescribed amount of time based on the output from vehicular velocity sensor 201.

When traffic jam tail end detection part 205b judges that the vehicle has arrived at the tail end of a traffic jam, information transmission part 205c transmits the latest vehicular velocity change information to information center 300 via communication device 209. This vehicular velocity change information pertaining to the tail end of the traffic jam is stored in vehicular velocity change information storage memory 208 at this point in time. That is, information transmission part 205c transmits coordinate values 22 of map data at the point the vehicle has arrived at the tail end of the traffic jam along with traveling direction 23 of the vehicle, traveling track 24 and vehicular velocity change record 25. In addition, as will be described later, information transmission part 205c transmits the vehicular velocity change information to information center 300 upon a request to transmit vehicular velocity change information by information center 300.

As will be described later, traffic jam avoidance control part 205d estimates the condition of the traffic jam ahead of the vehicle based on estimated tail end information received from information center 300. That is, traffic jam avoidance control part 205d estimates the position of the tail end of the current traffic jam. Then, it outputs a message prompting the driver to decide whether the traffic jam should be bypassed or not via monitor 206 and speaker 207. Here, as will be described later, the estimated tail end information includes information for estimating the increase or decrease in the length of the traffic jam.

As a result, if the driver responds by actuating operation switch 204 to instruct bypass of the traffic jam, an appropriate alternate route is found based on the distance between the vehicle included in the estimated tail end information, the latest estimated traffic jam tail end, the trend in the transition of increase or decrease in the traffic jam, and an expected arrival time at the preset destination if the alternate route is used is computed. The found alternate route and the expected arrival time computed can be output to monitor 206 in order to present them to the driver.

When determining the tail end of the traffic jam, if a prescribed amount of time or more has already passed since the last reception of estimated tail end information from information center 300, a request for estimated tail end information is transmitted to information center 300 in order to determine the tail end of the traffic jam based on the latest estimated tail end information.

Information center 300 is configured with a CPU, a memory and other peripheral circuits necessary to perform various kinds of processing to be described later. As shown in FIG. 1, this circuitry is in the form of a controller 301, such as a microcontroller. Information center 300 also includes communication device 302 that communicates with on-vehicle information terminals 200 via communication channels and information storage memory 303 that stores pieces of traffic jam tail end information and vehicular velocity change information received from on-vehicle information terminals 200.

Controller 301 has traffic jam tail end estimation part 301a, estimated tail end information transmission part 301b and information request part 301c.

Upon receiving the vehicular velocity change information from on-vehicle information terminal 200, traffic jam tail end estimation part 301a stores the received information in information storage memory 303. Here, the configuration may be such that only when pieces of vehicular velocity change information that contain the same link ID and similar coordinate values are received from on-vehicle information terminals 200 installed on multiple vehicles. That is, when pieces of vehicular velocity change information containing similar positional information are received, is a judgment made that a traffic jam is present on the link, and the information is stored in information storage memory 303 in order to prevent stoppage of a vehicle for a reason other than a traffic jam. For example, if only one set of vehicular velocity change information is received, it is possible to mistake a temporary stop on a road shoulder as a traffic jam.

A link ID contained in the latest vehicular velocity change information received from vehicle information terminal 200 is obtained, and whether the same link ID is present in the stored vehicular velocity change information is determined. If a judgment is made that the same link ID is present, passage of time ΔT between the point in time at which the vehicular velocity information with the same link ID was received and the point in time at which the latest vehicular velocity change information was received is computed. Furthermore, difference ΔL in the tail end position is computed based on the coordinate values at the tail end of the traffic jam at the respective points in time, and an approximation formula for the transition of the traffic jam tail end position that is used to predict traffic jam tail end position Y after X minutes is defined as Formula (1) given below.
Y=ΔL/ΔT*X (1)

In addition, when ΔL/ΔT that indicates an increase (or decrease) in the length of a traffic jam per unit time is denoted as α, α (α1) computed when traffic jam tail end information was previously received is compared with the latest α (α2) in order to compute the trend in the transition of the traffic jam. That is, Δα=α2−α1 is computed as the trend in the increase or decrease of the traffic jam. Then, these approximations Y, ΔT, ΔL, α, and Δα are stored in information storage memory 303 as traffic jam tail end information.

If few vehicles with on-vehicle information terminal 200 are available the approximation formula for the transition of the traffic jam tail end position and the trend in the transition of the increase or decrease of the traffic jam are updated at longer intervals, and the reliability may drop. Thus, the traffic jam tail end information may be erased from information storage memory 303 if a prescribed amount of time has passed since the last traffic jam tail end information was received.

Estimated tail end information transmission part 301b transmits the traffic jam tail end information stored in information memory 303 by traffic jam tail end estimation part 301a, that is, approximations Y, ΔT, ΔL, α, and Δα, to on-vehicle information terminal 200 as information to be used for estimating the increase or decrease of the traffic jam. In other words, when the traffic jam tail end information in information memory 303 is updated upon receiving the latest vehicular velocity change information from on-vehicle information terminal 200, the latest estimated tail end information is transmitted to on-vehicle information terminal 200.

Upon receiving a request to transmit the latest estimated tail end information from traffic jam avoidance control part 205d of on-vehicle information terminal 200, information request part 301c sends a request to transmit the latest velocity change information to all vehicles having the same link ID as the link ID on which the vehicle that made the transmission request is traveling and the same traveling direction based on the pieces of velocity change information received within an immediately preceding prescribed amount of time. In addition, if a prescribed amount of time has already passed since the traffic jam tail end information was stored into information storage memory 303 by traffic jam tail end estimation part 301a, information request part 301c requests transmission of the latest velocity change information by all on-vehicle information terminals 200.

The information center 300 carries out the described processing based on the pieces of velocity change information received from on-vehicle information terminals 200 in response to these requests and transmits the latest estimated tail end information to the on-vehicle information terminal 200 that initially requested the information.

At on-vehicle information terminal 200 that received the estimated tail end information, traffic jam avoidance control part 205d estimates the condition of the traffic jam ahead of the vehicle based on the information in the manner described above. More specifically, traffic jam avoidance control part 205d estimates the current tail end position of the traffic jam based on approximations Y and Δα as information for estimating the increase or decrease in the length of the traffic jam. Then, if a search for an alternate route is instructed by the user in order to avoid the traffic jam (by actuation of operation switch 204 by example), traffic jam avoidance control part 205d finds an alternate route that minimizes travel in the jammed section considering the tail end position of the current traffic jam and presents the alternate route to the driver.

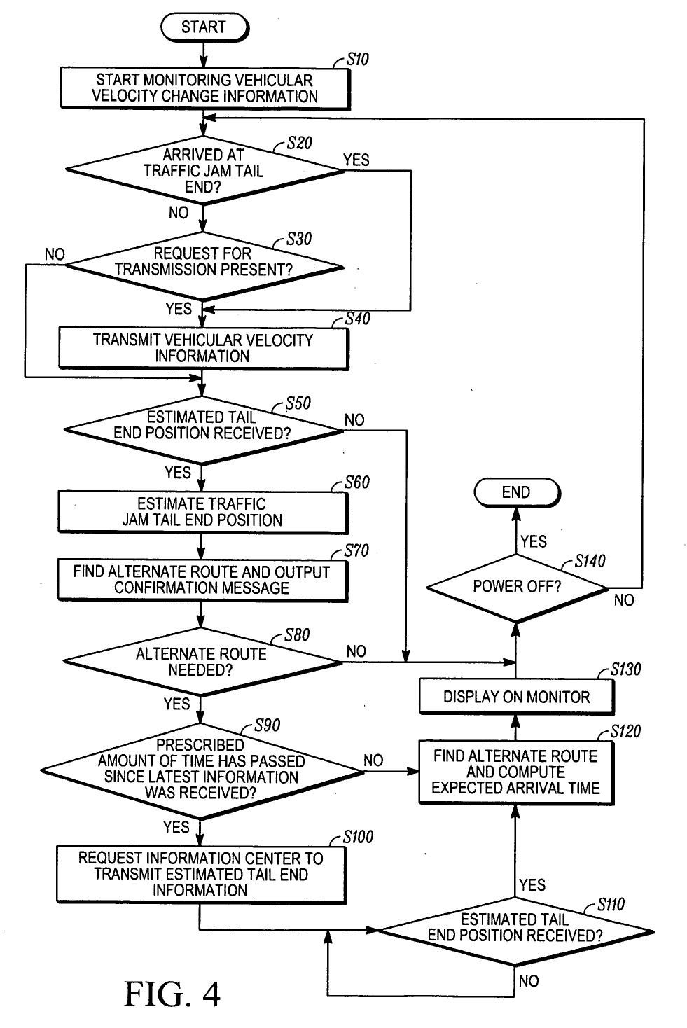

FIG. 4 is a flow chart showing the processing carried out by on-vehicle information terminal 200 in the present embodiment. The processing shown in FIG. 4 is executed by controller 205 as a program activated when on-vehicle information terminal 200 is turned on.

In step S10, vehicular velocity change information monitor part 205a begins monitoring the vehicular velocity change information in vehicular velocity change information storage memory 208. Advancing to step S20, traffic jam tail end detection part 205b determines whether the vehicle has arrived at the tail end of the traffic jam or not based on an output from vehicular velocity sensor 201. If traffic jam tail end detection part 205b judges that the vehicle has arrived at the tail end of the traffic jam, information transmission part 205c transmits the vehicular velocity change information stored in vehicular velocity change information storage memory 208 to information center 300 via communication device 209 in step S40. Subsequently, advancement is made to Step S50. However, traffic jam tail end detection part 205b judges that the vehicle has not yet arrived at the tail end of the traffic jam, advancement is made to step S30.

In step S30, whether a vehicular velocity change information transmission request has been received from information center 300 or not is determined. If no transmission request has been received, advancement is made to step S50 to be described later. On the other hand, if a transmission request has been made, processing advances to step S40. In step S40, information transmission part 205c transmits the vehicular velocity change information stored in vehicular velocity change information storage memory 208 to information center 300 via communication device 209. Subsequently, advancement is made to step S50.

In step S50, traffic jam avoidance control part 205d determines whether or not the estimated tail end information has been received from information center 300. If the estimated tail end information has not been received, processing advances to step S140 to be described later. On the other hand, if the estimated tail end information has been received, processing advances is made to step S60. In step S60, the tail end position of the traffic jam is estimated based on the received estimated tail end information, and a message prompting the driver to decide whether the traffic jam should be bypassed or not is output via monitor 206 and speaker 207 upon advancing to step S70.

Subsequently, upon advancing to step S80, whether it is necessary to find an alternative route or not is determined based on the driver's response to the message. If the driver has not selected a search for an alternative route, processing advances to step S140 to be described later. On the other hand, if the driver elects to find an alternate route, processing advances to step S90. In step S90, a query is made as to whether or not at least a prescribed amount of time has passed since the latest estimated tail end information was received from information center 300. If the prescribed amount of time has not yet passed, processing advances to step S120, discussed hereinafter, where processing advances to step S100 if at least the prescribed amount of time has passed.

In step S100, a request is made to information center 300 to transmit the latest estimated tail end information, and processing advances to step S110. In step S110, whether or not the latest estimated tail end information has been received from information center 300 is determined. Once the latest estimated tail end information has been received, processing advances to step S120, in which an appropriate alternate route is found considering the current tail end position of the current traffic jam estimated based on the estimated tail end information. Also in this step, an expected arrival time at the preset destination upon use of the alternate route is computed.

Upon advancement to step S130, the newly-found alternate route and the expected arrival time computed are displayed on monitor 206 before processing advances to step S140. In step S140, a query is made regarding the status of the power to on-vehicle information terminal 200. If the power is not off, the process is repeated by returning to step S20. However, if the power is off, processing ends.

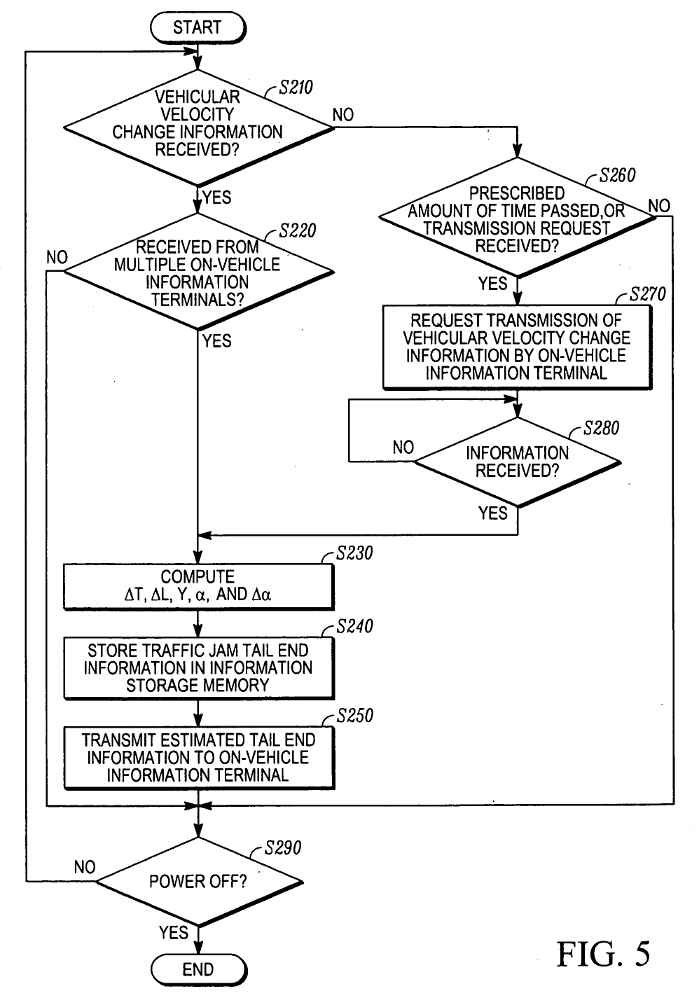

FIG. 5 is a flow chart showing the processing carried out by information center 300 in an embodiment. The processing shown in FIG. 5 is executed by controller 301 as a program activated when the power to information center 300 is turned on.

In step S210, traffic jam tail end estimation part 301a determines whether or not vehicular velocity change information has been received from on-vehicle information terminals 200. If no vehicular velocity change information has been received, processing advances to step S260, discussed hereinafter. In contrast, if vehicular velocity change information has been received, processing advances to step S220.

In step 220, whether or not pieces of vehicular velocity information containing the same link ID and similar coordinate values have been received from multiple on-vehicle information terminals 200 is determined. If such velocity information has not been received from multiple on-vehicle information terminals 200, processing advances to step S290, also discussed hereinafter. But, if velocity information containing the same link ID and similar coordinate values has been received, processing advances to step S230.

As described above, ΔT, ΔL and approximations Y, α, and Δα are computed in step S230, and these computation results are stored in information storage memory 303 as traffic jam tail end information upon advancement to step S240. In step S250, estimated tail end information transmission part 301b transmits the latest traffic jam tail end information to on-vehicle information terminal 200 as estimated tail end information, and processing advances to step S290.

Next, processing to be carried out when vehicular velocity change information has not been received in response to the query in step S210 will be explained. In this case processing advances to step S260 where information request part 301c determines whether a latest estimated tail end information transmission request has been received from on-vehicle information terminal 200 or whether at least a prescribed amount of time has passed since the last storing of traffic jam tail end information in information memory 303. If the answer to both queries is no, processing advances to step S290. However, if either the latest estimated tail end information request was received or at least a prescribed amount of time passed, processing advances to step S270.

As described previously, a request is made to on-vehicle information terminal 200 to transmit vehicular velocity change information in step S270. Whether or not vehicular velocity change information has been received from on-vehicle information terminal 200 is determined upon advancing to step S280. If vehicular velocity change information has been received, advancement is made to step S290.

In step S290, a query is made as to whether the power to information center 300 is turned off or not. If the power to information center 300 is not off, processing continues by returning to step S210. However, if the power to information center 300 is off, processing ends.

The following effects can be attained by the teachings herein. First, information center 300 is designed to estimate the traffic jam tail end position on a link based on the pieces of vehicular velocity change information received from on-vehicle information terminals 200 and further is designed to compute the trend in the increase or decrease of a traffic jam in order to compute information to be used for estimating the increase or decrease in the length of the traffic jam. As such, because the traffic jam condition can be estimated based on pieces of vehicular velocity change information received from vehicles actually traveling on the road, the information for estimating the increase or decrease in the length of the traffic jam can be computed highly accurately.

Second, on-vehicle information terminal 200 is designed to judge that the vehicle has arrived at the tail end of the traffic jam based on the output from vehicular velocity sensor 201 if the vehicular velocity is equal to or less than a prescribed value, and if the vehicle has continued at or less than the prescribed value for at least a prescribed amount of time. As a result, there is no need to install a traffic jam detector on the road to detect a traffic jam, and the system can be constructed inexpensively.

In another effect, at on-vehicle information terminals 200 traffic jam tail end detection part 205b is designed to estimate the current tail end position of the traffic jam based on the estimated tail end information received from the information center 300 and to find an alternate route considering the tail end position of the traffic jam. As a result, the traffic jam condition of a section where traffic information is not offered by a general public office can also be estimated, and an appropriate alternate route can be found considering the traffic jam conditions.

Additionally, at information center 300 traffic jam tail end estimation part 301a is designed in such a manner that when pieces of vehicular velocity change information with the same link ID and similar coordinate values are received from on-vehicle information terminals 200 installed on multiple vehicles, the information center 300 judges that there is a traffic jam on that link. As a result, false detection of a traffic jam when a vehicle has stopped for a reason other than a traffic jam, for example, a stop on a road shoulder, can be prevented.

Information center 300 is further designed to transmit the estimated tail end information to on-vehicle information terminal 200 when a request for transmitting estimated tail end information is received from on-vehicle information terminal 200, or when the traffic jam tail end information is updated as the pieces of vehicular velocity change information are received from on-vehicle information terminals 200. As a result, estimated traffic jam information based on the latest road condition can be presented to on-vehicle information terminals 200 at all times.

The traffic jam detection system described above can be modified in a number of ways. In the described embodiments, vehicular velocity change information monitor part 205a judges whether the vehicle had arrived at the tail end of the traffic jam when the vehicular velocity is equal to or less than a prescribed value for at least a prescribed amount of time based on the output from vehicular velocity sensor 201. However, this does not impose any restriction. The arrival of the vehicle at the tail end of the traffic jam may be judged when the vehicle has come to a stop, or when a low-speed tracking device is actuated by the driver and low-speed cruising by tracking is initiated, for example.

Also in the description, an example was provided in which when pieces of vehicular velocity change information containing the same link ID and similar coordinate values are received from on-vehicle information terminals 200 installed on multiple vehicles, traffic jam tail end estimation part 301a concludes that there exists a traffic jam on that link. However, this does not impose any restriction. For example, within similar coordinates with the same link ID, when vehicular velocity change information is received from certain vehicle A, yet vehicular velocity change information received from another vehicle B indicates that vehicle B has passed the point without stopping, a judgment may be made that only the lane on which vehicle A is traveling is congested in order to determine the traffic jam condition for each lane.

The relationship between the constituents under the claims and in the embodiment will be explained. Traffic jam tail avoidance control part 205d corresponds to the estimation means, and the traffic jam tail end estimation means corresponds to the computation means. However, the aforementioned explanation is merely an example, and interpretations of the invention are by no means not restricted to the correlation between the items described in the aforementioned embodiment and the items described under the claims.

This application is based on Japanese Patent Application No. 2005-189701, filed Jun. 29, 2005, in the Japanese Patent Office, the entire contents of which are hereby incorporated by reference.

Also, the above-described embodiments have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. A traffic jam detection system, comprising:
a first on-vehicle information terminal including
a controller operable to detect an arrival of the vehicle at a tail end of a traffic jam; and
a communication device adapted to transmit information regarding the tail end of the traffic jam external of the vehicle and to receive estimated traffic jam information from external of the vehicle.

2. The system according to claim 1, further comprising:
a velocity sensor that outputs velocity information for the vehicle; and
a global positioning unit that outputs a position of the vehicle; and wherein the information regarding the tail end of the traffic jam includes the position of the vehicle, a travel direction of the vehicle and changes in the velocity of the vehicle.

3. The system according to claim 2 wherein the controller is responsive to the velocity sensor to detect an arrival of the vehicle at the tail end of the traffic jam based on changes in the velocity of the vehicle.

4. The system according to claim 1 wherein the controller is further operable to detect the arrival of the vehicle at the tail end of a traffic jam when a velocity of the vehicle is one of less than and equal to a prescribed velocity for at least a minimum time period.

5. The system according to claim 1 wherein the information regarding the tail end of the traffic jam includes a position of the tail end of the traffic jam, a travel direction of the vehicle, and changes in a velocity of the vehicle.

6. The system according to claim 1 wherein the controller is operable to transmit the information regarding the tail end of the traffic jam over the communications device when at least one of the controller detects the arrival of the vehicle at the tail end of the traffic jam and the controller receives a request for the information regarding the tail end of the traffic jam from external of the vehicle.

7. The system according to claim 1 wherein the controller is further operable to estimate a condition of a current traffic jam ahead of the vehicle using at least some of the estimated traffic jam information.

8. The system according to claim 7 wherein the condition of the current traffic jam comprises one of an increase and a decrease in a length of the current traffic jam.

9. The system according to claim 1, further comprising:
an information center adapted to wirelessly communicate with a plurality of on-vehicle information terminals including the first on-vehicle information terminal, the information center including:
a central communication device adapted to receive the information regarding the tail end of the traffic jam and to transmit the estimated traffic jam information to the plurality of on-vehicle information terminals; and
a central controller operable to use the information regarding the tail end of the traffic jam to determine the estimated traffic jam information.

10. The system according to claim 9 wherein the central controller is further operable to compare the information regarding the tail end of the traffic jam provided by two or more of the on-vehicle information terminals on respective vehicles in proximity to a location to determine a presence or an absence of a current traffic jam at the location.

11. The system according to claim 9 wherein the estimated traffic jam information comprises
a passage of time between receipt by the information center of information regarding a tail end of a second traffic jam from a first vehicle and a receipt by the information center of a second set of information regarding the tail end of the second traffic jam from a second vehicle; and
a difference in a tail position of the tail end of the second traffic jam included with the information regarding the tail end of the second traffic jam and a second tail position of the tail end of the second traffic jam included with the second set of information regarding the tail end of the second traffic jam.

12. A traffic jam detection system, comprising:
means for transmitting information pertaining to a tail end of a traffic jam from a vehicle to an information center when an arrival of the vehicle at the tail end of the traffic jam is detected;
means for receiving current information for estimating a condition of a current traffic jam ahead of the vehicle; and
means for estimating the condition of the current traffic jam ahead of the vehicle based on the current information.

13. A traffic jam detection method, comprising:
transmitting information pertaining to a tail end of a traffic jam from a vehicle to an information center when an arrival of the vehicle at the tail end of the traffic jam is detected;
receiving current information for estimating a condition of a current traffic jam ahead of the vehicle; and
estimating the condition of the current traffic jam ahead of the vehicle based on the current information.

14. The method according to claim 13 wherein the condition of the current traffic jam is one of an increase and a decrease in a length of the current traffic jam.

15. The method according to clam 13, further comprising:
receiving respective information pertaining to tail ends of plural traffic jams from plural vehicles at the information center, including the tail end of the traffic jam from the vehicle;
calculating respective current information for estimating respective conditions of the plural traffic jams using the respective information, including the current information for estimating the condition of the current traffic jam ahead of the vehicle; and
transmitting the current information for estimating the condition of the current traffic jam ahead of the vehicle to the vehicle from the information center.

16. The method according to claim 15 wherein the respective information pertaining to tail ends of plural traffic jams includes respective positions of the tail ends of the plural traffic jams, directions of travel of the respective plural vehicles, and changes in respective velocities of the plural vehicles; and wherein calculating respective current information for estimating respective conditions of the plural traffic jams using the respective information further comprises calculating respective current information for estimating one of an increase and a decrease in a length of each of the plural traffic jams.

17. The method according to claim 15 wherein, for respective ones of the plural traffic jams, calculating the respective current information comprises
calculating a passage of time between receipt by the information center of the information pertaining to the tail end of the traffic jam and a receipt by the information center of a second set of information pertaining to the tail end of the traffic jam from a second vehicle; and
calculating a difference in a tail position of the tail end of the traffic jam included with the information pertaining to the tail end of the traffic jam and a second tail position of the tail end of the traffic jam included with the second set of information pertaining to the tail end of the traffic jam.

18. The method according to claim 13, further comprising:
detecting the arrival of the vehicle at the tail end of the traffic jam based on changes in velocity of the vehicle.

19. The method according to claim 13 wherein the information pertaining to the tail end of the traffic jam includes a position of the tail end of the traffic jam, a direction the vehicle is traveling, and changes in a velocity of the vehicle.

20. The method according to claim 13, further comprising:
comparing the information pertaining to the tail end of the traffic jam with separate information from at least one other vehicle at a similar location to determine a presence or an absence of the at least one current traffic jam at the similar location.
